(19) United States
(12) Patent Application Publication
(10) Pub. No.: US 2020/0271517 A1
(43) Pub. Date: Aug. 27, 2020

(54) Method for quantifying a material or material mixture

(71) Applicant: Tailorlux GmbH, Munster, DE (US)

(72) Inventor: Alex Deitermann, Munster (DE)

(21) Appl. No.: 16/488,165

(22) PCT Filed: Feb. 23, 2018
(86) PCT No.: PCT/DE2018/100161

§ 371 Date: Aug. 22, 2019

(30) Foreign Application Priority Data
Feb. 23, 2017 (DE) 10 2017 103 780.2

(51) Int. Cl. G01J 3/28; G01N 21/64; G01J 3/44; G01J 3/443

(52) U.S. Cl. CPC G01J 3/2823; G01N 21/6428; G01J 3/4406; G01N 2021/8444; G01N 2021/6439; G01J 2003/2826; G01J 3/443

(57) ABSTRACT

A method is claimed for identifying and quantifying a material or mixture of materials, where the material or the mixture of materials comprises one or more components X identifiable by means of spectroscopic methods and/or with a hyperspectral camera. The method comprises the steps of

A. generating one or more signals by excitation with a radiation source in the range of 280-1100 nm and recording thereof by a suitable spectrometer system, a hyperspectral camera or a photodiode,
B. evaluating the signal(s) and/or hyperspectral image(s) obtained and assigning the signal(s) and/or hyperspectral image(s) to a component X, and subsequently assigning the identified component X to a material or a mixture of materials,
C. quantitatively determining the material or mixture of materials.

The present invention relates to a method for identifying and quantifying a material or a mixture of materials, where the material or the mixture of materials comprises one or more phosphors/taggants which are invisible in daylight.

For the manufacturers of high-value branded products, monitoring and maintaining the quality of branded products, in relation to maintaining the quality of the starting materials, is a major problem in light of the ever-increasing globalization. The globalization of the economic world has meant that raw materials, intermediates, and the end products are obtained and processed in different locations and are also transported over long distances. In the processing and upgrading of raw materials, which frequently also takes place at a great distance from where the clients are located, there are continually attempts to adulterate and extend the starting materials with low-grade raw materials in order to save on the use of high-grade starting materials. In the manufacture of textiles, in particular, it has been observed that high-grade cotton fibers are adulterated with lower-grade fibers and subsequently woven or knitted. Especially if the quantities of lower-grade fibers used are not too large, the reduced quality of the end product is noticed not in the manufacturing process itself, but instead only by the eventual customers.

The problem of high-grade starting materials being adulterated or extended with lower-grade materials occurs not only with cotton but also with many other high-grade and high-priced fibers, such as cashmere, merino wool and also silk, and also with other natural and synthetic fibers which are used in the manufacture of high-priced branded products. Other materials as well, offered for example in the form of bulk materials, are extended by addition of lower-grade products. Examples that may be given here include natural products such as fruits, nuts, cereals, seed, paints and varnishes, ink and other printing products, and also plastics and chemicals.

An object of the present invention, accordingly, was to provide a method enabling the starting materials used to be tagged and recognized by means of suitable metrology, in other words identified, and also making it possible to specify whether the composition of the material or mixture of materials corresponds to the desired composition mandated by the producers (quantification).

A subject of the present invention, therefore, is a method for identifying and quantifying a material or mixture of materials, where the material or the mixture of materials comprises one or more components X identifiable by means of spectroscopic methods and/or with a hyperspectral camera,

said method comprising the steps of

A. generating one or more signals by excitation with a radiation source in the range of 280-1100 nm and recording thereof by a suitable spectrometer system, a hyperspectral camera or a photodiode,

B. evaluating the signal(s) and/or hyperspectral image(s) obtained and assigning the signal(s) and/or hyperspectral image(s) to a component X, and subsequently assigning the identified component X to a material or a mixture of materials,

C. quantitatively determining the material or mixture of materials.

With the method of the invention it is possible to identify materials and mixtures of materials, employed as raw or semifinished products, in the end products and also to determine the quantitative fraction thereof in a product. If it has been determined, for example, that the material or mixture of materials to be identified is present in a product, it is possible, furthermore, to determine whether this raw or semifinished product for identification is also present in the desired amount or in the amount which has been specified, or whether other components have been mixed into the product.

In this way it is possible to verify whether, especially when using expensive materials and mixtures of materials, these materials also actually are being used or have been used in the desired quality. In a further embodiment, the quantitative determination of component X can be used to draw conclusions about the quality of the material or mixture of materials.

In accordance with the invention, the components X are to be identifiable by means of spectroscopic methods and/or by hyperspectral camera and/or by a photodiode. Spectroscopic methods contemplated include emission spectroscopy, absorption spectroscopy, reflection spectroscopy, and also recording and evaluation by means of hyperspectral imaging. A method used with preference in the context of the present invention is emission spectroscopy.

In a method step A, under defined excitation conditions, one or more signals of the component X are generated by excitation with a radiation source in the range of 280-1100 nm. The signals are detected by means of a suitable spectrometer system, a hyperspectral camera or a photodiode. Either individual signals, especially prominent signals (prominent peaks), or else complete spectra of component X can be detected, or one or more hyperspectral images can be recorded. In one possible embodiment, the signal or the spectrum or hyperspectral image is obtained in dependence on excitation pulses, as a function of the time, of the temperature and/or of the change in the ambient pressure. Where the term “signal” is used hereinafter, it refers to an individual signal or peak in an emission spectrum, but also to a complete spectrum or an image recorded using a hyperspectral camera, or a signal recorded by a photodiode.

The signals or spectra obtained, or the images recorded, are evaluated in the next method step B. Evaluation takes place by matching the signals or spectra or hyperspectral images obtained with the prescribed signals, spectra or hyperspectral images obtained for component(s) X under the same excitation conditions.

In the last method step C, component X is determined quantitatively according to methods known from the prior art. Customarily there is a change in the intensity of a signal in dependence on the concentration, with the change in the intensity of the measured signal or signals or recorded images at different concentrations also being dependent on the characteristics of the respective component X. By way of the methods employed, therefore, component X is to be not only identifiable but also quantifiable. For the quantitative determination of component X as well, the signals may be obtained in dependence on excitation pulses, as a function of the time, of the temperature and/or of the change in the ambient pressure. The change in the intensity of the signal may be linear or else nonlinear. Where the change in the intensity of the signal, spectrum or image in dependence on the concentration, i.e., on the amount present in the sample under analysis, of component X is not known from the literature, it has proven advantageous to carry out model measurements. In these model measurements, the alterations in the signals and/or images are measured under known conditions and for a known amount of component X present, and displayed graphically, either in table form or as a diagram (including by means of appropriate software), or else converted into a mathematical model. At the evaluation stage, these model measurements can serve as a basis for determining the concentration of component X in the product under investigation. The amount of component X present may be determined manually by means of compiled tables or diagrams or else by mathematical operations in relation to an ascertained reference value/ratio/signal/spectrum for the material or mixture of materials, or else end product, under investigation, with respect to the product defined as a reference variable. From the qualitative and quantitative determination of component X it is possible to ascertain whether and, if so, in what proportion the material or mixture of materials under investigation has been supplied or processed in a product. In this way it is possible to investigate, in the ongoing production operation or in the end product, whether the stipulated materials and mixtures of materials have actually been used, and in the desired amount as well.

The components X may be selected from any desired optically and spectroscopically identifiable substances. These substances may either be directly added to the material or mixture of materials, or may be present in this material or mixture of materials, or component X may be incorporated in a separate carrier material which is added to the material or mixture of materials and/or incorporated into this material. Both within the material or mixture of materials, or if it is incorporated into a carrier, the component X ought to be chemically and physically stable and ought also to have barely any adverse effect, or none, on the properties of the material. Highly suitable substances that may be used as component X include organic complex compounds, organic phosphors and/or inorganic phosphors. These phosphors, also known as luminescence agents or luminescent substances, are already widely used in the identification of articles, as in the case of banknotes and other documents of value, for example. Organic complex compounds and/or phosphors may be selected from organically conjugated systems such as fluorescein derivatives, coumarin derivatives, oxazine derivatives, rhodamine derivatives, Lumogens, pyrromethene dye derivatives or others. Suitable for the use of complex compounds are complexes of the rare earths with Eu³⁺, Tb³⁺, Sm²⁺, Sm³⁺, Nd³⁺, Ce³⁺, Pr³⁺, Pr⁴⁺, Dy³⁺, Ho³⁺, Er³⁺, Tm³⁺, Yb²⁺ or Yb³⁺, but also complex compounds with Ru³⁺, Cr³⁺, Mn²⁺, Mn³⁺, Mn⁴⁺, Fe³⁺, Fe⁴⁺, Fe⁵⁺, Co³⁺, co⁴⁺, Ni²⁺, Eu²⁺, Tb⁴⁺, Ce⁴⁺, or Cu⁺ complexed with organic, conjugated ligands such as acetylacetone (ACAC), dibenzoylmethane (DBM), 4,4,4-trifluoro-1-(2-naphthyl)-1,3-butanedione (TFNB), thenoyltrifluoroacetone (TTFA), bipyridine derivatives, phenanthroline derivatives or other organic, complexing ligands. Inorganic phosphors may be selected solid-state compounds which comprise one or more luminescent ions from the group of In⁺, Sn²⁺, Pb²⁺, Sb³⁺, Bi³⁺, Ce³⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, Ti⁴⁺, V²⁺, V³⁺, V⁴⁺, Cr³⁺, Mn²⁺, Mn³⁺, Mn⁴⁺, Fe³⁺, Fe⁴⁺, Fe⁵⁺, Co³⁺, Co⁴⁺, Ni²⁺, Cu⁺, Ru²⁺, Ru³⁺, Pd²⁺, Ag⁺, Ir³⁺, Pt²⁺, Zr⁴⁺, Hf⁴⁺, and Au⁺. Preferred are inorganic luminescent pigments, binary, ternary or quaternary halides, oxides, oxyhalides, sulfides, oxysulfides, sulfates, oxysulfates, selenides, nitrides, oxynitrides, nitrates, oxynitrates, phosphides, phosphates, carbonates, silicates, oxysilicates, vanadates, molybdates, tungstates, germanates or oxygermanates of the elements Li, Na, K, Rb, Mg, Ca, Sr, Sc, Ba, Y, La, Ti, Zr, Hf, Nb, Ta, Zn, Gd, Lu, Al, Ga, and In. In addition to the identification of the labeling, quantitative determination in the product takes place. For this it is necessary to ensure that the incorporation of the labeling into the desired product is extremely homogeneous and does not alter over time, so that the reference to the defined and averaged reference continues to apply.

The qualitative and also quantitative determination of component X may take place, as described above, with the aid of various types of sensor, by referencing relative to the stipulated product. The types of sensor in accordance with the method include in particular the following enumeration:
Photodiodes: determination of the (wavelength-dependent) intensity of the emission as a response to the excitation by radiation with a wavelength of 280-1100 nm, by the determination of the current strength and subsequent metrological matching of the sample with a specimen, and identification of the quantity of the tagging in the sample.
Hyperspectral camera: determination of the spectral emission intensity of individual image pixels, intensity of the optical signal (as a response to the excitation by light) radiation with a wavelength of 280-1100 nm, and metrological matching of the sample with a specimen, and identification of the quantity of the tagging in the sample.
Fluorescence spectroscopy: determination of the wavelength-dependent intensity of the radiant emission as a response to the excitation by radiation with a wavelength of 280-1100 nm, and metrological matching of the sample with a specimen, and identification of the quantity of the tagging in the sample.

The measurements necessary for determining the quantity of the labeled material may take place both manually and automatically, i.e., offline or online, for the respective types of sensor. Furthermore, the measurements needed for determining the quantity of the labeled material may take place either at one measurement location or at an arbitrary number of measurement locations, and may record a number from 1 to infinity of samples or measurement values in order to collect emission data. The subsequent determination of concentration (quantification) may take place, as described above, manually or else by means of mathematical methods, and also by the matching with a data model developed for the particular component X.

With the method of the invention it is possible to identify materials and mixtures of materials and also to establish whether the tagged materials/products are present in the desired quantity. Examples of suitable mixtures of materials which can be identified are fibers, such as plant fibers, animal fibers, synthetic fibers or mineral fibers. The fibers may be intermediates, examples being threads or filaments, and may also be products of these threads and filaments. Examples of fibers are plant fibers, such as fibers of cotton, kapok, flax, hemp, jute, ramie, sisal, coir, etc., and also animal fibers, i.e., protein-based fibers, such as sheep wool, goat hair (mohair), cashmere or tibet wool, alpaca, lama, and vicuna wool, camel hair, angora, horse hair, and any desired further animal hairs. Other examples are silk, such as mulberry silk or else wild silks (tussah silk). Also technical fibers such as mineral fibers and also synthetic fibers, i.e., comprising polymers, such as polyester fibers, polyamide fibers or aramid fibers, polyvinyl chloride, polyolefin, polyvinylidene chloride, polyvinyl acetate, or multipolymers such as modacrylic, polyurethanes, and elastane. Examples of inorganic-based fibers are glass fibers, metal fibers, and mineral fibers.

Any desired other materials and mixtures of materials as well, present in the form of liquids or bulk products, may be admixed with a component X in order for these materials to be identified and for the quality of the material to be verified by quantification of the labeled material. These further materials may be chemicals, plastics and plastics products, minerals, liquids, plants, fruits, seed, and animal products, and also substances and commodities obtained from them.

In one preferred embodiment the material or mixture of materials are fiber materials, more particularly comprising natural fibers, such as cotton. The cotton fibers may comprise a defined fraction of adjuvants, examples being plastic or cellulose, incorporating one or more components X.

The incorporation or application of the component X into or onto the material or mixture of materials may take place in any suitable way, such as, for example, by integration into fibers, mixing of tagged fibers into untagged fibers, coating of fibers, integration of taggants into filaments (threads), coating of filaments, coating of textile products (woven and nonwoven), coating, especially painting or coloring, varnishing, rotational coating, spray varnishing, thermal spraying, plastifying, dip coating (anodic or cathodic), melt dipping, enameling, slot die coating, knife coating, dip coating, spray coating, roll coating, multiple coating by cascade or curtain coating, sol-gel, thermal spraying, powder coating, tumbling, fluid-bed sintering, printing of materials, articles, and products (integration via printing colors, printing inks, print varnishes, primers or any other printing media) via all printing processes.

In one possible embodiment of the present invention, textile fibers are tagged, and textile materials obtained from them are identified, and their quality is verified quantitatively in terms of the fraction of tagged fibers. Natural fibers are first spun and then processed further in conventional processing methods, generally by weaving or knitting, to form woven and knitted fabrics. The natural fibers are frequently admixed with further fibers in order appropriately to establish the quality and the properties of the finished product. The further fibers which may be added to the natural fibers include, for example, manmade fibers. One possible embodiment of the present invention uses manmade fibers (e.g., cellulose fibers) which comprise a component X. The natural fiber is spun together with the manmade fiber, or the manmade fiber is added before the further processing of the natural fiber and/or is incorporated during the weaving or knitting process. The product obtained, the spun fiber or the textile material in the form of the woven or knitted fabric, is subsequently processed further to give the textile product. In order to ensure that the material involved is actually the desired material, or that the finished textile product has also been produced from the desired or specified material, it is possible, by generating a signal in the form of a spectrum and/or of an hyperspectral image of the component X, first to determine the component X itself, by evaluating the resultant spectrum and/or image and assigning a spectrum or image to a component X. From the intensities ascertained from the spectrum, it is possible ultimately to ascertain the amount of component X used (quantification). From the establishment of which component X has been used, and in what quantity, it is possible to check whether the measured material is the desired material which should actually have been processed in the textile piece, or whether it is (in part) a different material, possibly with reduced quantity. If, for example, the fiber used is extended with a different fiber, then component X is present in a smaller amount (quantity) in relation to the total amount. From this difference it is possible to conclude that the textile material has been extended with other fibers and therefore that the quality has been altered.

1. A method for identifying and quantifying a material or mixture of materials, where the material or the mixture of materials comprises one or more components X identifiable by means of spectroscopic methods and/or with a hyperspectral camera, said method comprising the steps of
A. generating one or more signals by excitation with a radiation source in the range of 280-1100 nm and recording thereof by a suitable spectrometer system, a hyperspectral camera or a photodiode,
B. evaluating the signal(s) and/or hyperspectral image(s) obtained and assigning the signal(s) and/or hyperspectral image(s) to a component X, and subsequently assigning the identified component X to a material or a mixture of materials,
C. quantitatively determining the material or mixture of materials.

2. The method as claimed in claim 1, characterized in that component X is selected from organic and/or inorganic complexes and/or phosphors.

3. The method as claimed in claim 2, characterized in that component X is selected from organic phosphors consisting of organically conjugated systems such as fluorescein derivatives, coumarin derivatives, oxazine derivatives, rhodamine derivatives, Lumogens, pyrromethene dye derivatives or others.

4. The method as claimed in claim 2, characterized in that component X is selected from metal-organic complex compounds with a preferred composition of complexes of the rare earths with Eu³⁺, Tb³⁺, Sm²⁺, Sm³⁺, Nd³⁺, Ce³⁺, Pr³⁺, Pr⁴⁺, Dy³⁺, Ho³⁺, Er³⁺, Tm³⁺, Yb²⁺ or Yb³⁺ but also complex compounds with Ru³⁺, Cr³⁺, Mn²⁺, Mn³⁺, Mn⁴⁺, Fe³⁺, Fe⁴⁺, Fe⁵⁺, Co³⁺, Co⁴⁺, Ni²⁺, Eu²⁺, Tb⁴⁺, Ce⁴⁺, or Cu⁺ complexed with organic, conjugated ligands such as acetylacetone (ACAC), dibenzoylmethane (DBM), 4,4,4-trifluoro-1-(2-naphthyl)-1,3-butanedione (TFNB), thenoyltrifluoroacetone (TTFA), bipyridine derivatives, phenanthroline derivatives or other organic, complexing ligands.

5. The method as claimed in claim 2, characterized in that component X is selected from inorganic phosphors based on solid-state compounds which comprise one or more luminescent ions from the group of In⁺, Sn²⁺, Pb²⁺, Sb³⁺, Bi³⁺, Ce³⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, Ti⁴⁺, V²⁺, V³⁺, V⁴⁺, Cr³⁺, Mn²⁺, Mn³⁺, Mn⁴⁺, Fe³⁺, Fe⁴⁺, Fe⁵⁺, Co³⁺, Co⁴⁺, Ni²⁺, Cu⁺, Ru²⁺, Ru³⁺, Pd²⁺, Ag⁺, Ir³⁺, Pt²⁺, Zr⁴⁺, He⁴ or Au⁺.

6. The method as claimed in claim 1, characterized in that the labeling is applied by one of the following methods into or onto the material to be labeled: integration into fibers, mixing of tagged fibers into untagged fibers, coating of fibers, integration of taggants into filaments (threads), coating of filaments, coating of textile products (woven and nonwoven), coating, especially painting or coloring, varnishing, rotational coating, spray varnishing, thermal spraying, plastifying, dip coating (anodic or cathodic), melt dipping, enameling, slot die coating, knife coating, dip coating, spray coating, roll coating, multiple coating by cascade or curtain coating, sol-gel, thermal spraying, powder coating, tumbling, fluid-bed sintering, printing of materials, articles, and products (integration via printing colors, printing inks, print varnishes, primers or any other printing media) via all printing processes.

7. The method as claimed in claim 1, characterized in that the signal or the hyperspectral image is obtained in dependence on excitation pulses, as a function of the time, of the temperature and/or of the change in the ambient pressure.

8. The method as claimed in claim 1, characterized in that the quantitative determination of component X takes place by photodiodes in dependence on excitation pulses, as a function of the time, of the temperature and/or of the change in the ambient pressure. Signals is obtained.

9. The method as claimed in claim 1, characterized in that the measurements required for determining the quantity of the labeled material can take place both manually and automatically, i.e., offline or online.

10. The method as claimed in claim 1, characterized in that the material or mixture of materials is selected from plant fibers, animal fibers, mineral fibers, synthetic fibers, chemicals, plastics and plastic products, minerals, liquids, adhesives, paints, inks, varnishes, building materials, natural products such as plants, fruits, seed or animal products, and also materials, substances, products, and commodities that are produced or obtained therefrom.

11. The method as claimed in claim 10, characterized in that the fiber is a cotton fiber which comprises a defined fraction of adjuvants, where the adjuvants are plastics fibers or cellulose fibers incorporating one or more components X.

12. The method as claimed in claim 5, characterized in that the inorganic phosphors are selected from binary, ternary or quaternary halides, oxides, oxyhalides, sulfides, oxysulfides, sulfates, oxysulfates, selenides, nitrides, oxynitrides, nitrates, oxynitrates, phosphides, phosphates, carbonates, silicates, oxysilicates, vanadates, molybdates, tungstates, germanates or oxygermanates of the elements Li, Na, K, Rb, Mg, Ca, Sr, Sc, Ba, Y, La, Ti, Zr, Hf, Nb, Ta, Zn, Gd, Lu, Al, Ga, and In.
